(19) United States
(12) Patent Application Publication
(10) Pub. No.: US 2004/0148763 A1
(43) Pub. Date: Aug. 5, 2004

(54) Dispensing system and method

(76) Inventors: David S. Peacock JR., Billerica, MA (US); Thomas C. Prentice, Westford, MA (US); Brian P. Prescott, Fremont, NH (US); Thomas Purcell, Atkinson, NH (US); Gary T. Freeman, Attleboro, MA (US); Kevin J. Courtemanche, Newburyport, MA (US); Scott A. Reid, Bradford, MA (US); Earl Sweet JR., Danville, NH (US); Murray D. Scott, Hudson, NH (US); Robert W. Tracy, Haverhill, MA (US); Paul L. Hemond, Attleboro, MA (US)

Correspondence Address: MINTZ, LEVIN, COHN, FERRIS, GLOVSKY, AND POPEO, P.C., ONE FINANCIAL CENTER, BOSTON, MA, 02111, US

(21) Appl. No.: 10/661,830

(22) Filed: Sep. 12, 2003

Related U.S. Application Data
(60) Provisional application No. 60/432,483, filed on Dec. 11, 2002.

(51) Int. Cl. B23P 19/00

(52) U.S. Cl. 29/739

(57) ABSTRACT

A system and method for performing operations on a plurality of workpieces comprises an operations portion and a load/unload portion, a plurality of independently operable work heads located in the operations portion, the work heads each being operable to perform work on the plurality of workpieces, a transfer system, the transfer system including a plurality of mounting devices, the transfer system being operable to deliver the mounting devices into and out of the operations portion of the system, the plurality of workpieces being contained in workpiece-holding structures, the workpiece-holding structures being mountable on the plurality of mounting devices, wherein one of the plurality of mounting devices is positioned in the operations portion of the system and work is performed on the plurality of workpieces by at least one of the plurality of independently operable work heads while another one of the plurality of mounting devices is positioned in the load/unload portion of the system and workpiece-holding structures are unloaded from the mounting devices.

### CLAIM OF PRIORITY

This application claims the benefit of priority under 35 U.S.C. §119(e) to copending U.S. Provisional Application No. 60/432,483, filed on Dec. 11, 2002, the entire contents of which are incorporated herein by reference.

### FIELD OF THE INVENTION

The invention relates generally to a system and method for performing a plurality of work operations in parallel using a plurality of work devices within one workstation. More specifically, the present invention relates to an apparatus and method for controlling a dispensing system that dispenses small amounts of liquid on a plurality of substrates such as electronic component packages within a dispensing system.

### BACKGROUND OF THE INVENTION

There are several types of prior art dispensing systems used for dispensing metered amounts of liquid or paste for a variety of applications. One such application is the assembly of integrated circuit chips. In this application, dispensing systems are used in the process of encapsulating integrated circuits with an encapsulating material and in the process of underfilling flip-chip integrated circuits with an encapsulant. Prior art systems are also used for dispensing dots of liquid epoxy or solder paste onto circuit boards and integrated circuits. The liquid epoxy and solder is used to connect components to a circuit board or to an integrated circuit. The dispensing systems described above include those manufactured and distributed by Speedline Technologies, Inc., of Franklin, Mass. A challenge to the throughput efficiency of dispensing systems arises due to constant increase in the amount of interconnects beneath a die in today's high density packaging, as well as a decrease in the size of the gap to be filled.

In a typical dispensing system, a pump and dispenser assembly is mounted to a moving assembly for moving the pump and dispenser assembly along three mutually orthogonal axes (x, y, z) using servomotors controlled by a computer system or controller. To dispense a dot of liquid on a circuit board or other substrate at a desired location, the pump and dispenser assembly is moved along the horizontal x and y axes until it is located over the desired location. The pump and dispenser assembly is then lowered along the vertical z axis until the nozzle of the pump and dispenser assembly is at an appropriate dispensing height over the substrate. The pump and dispenser assembly dispenses a dot of liquid, is then raised along the z axis, moved along the x and y axes to a new location, and is lowered along the z axis to dispense the next liquid dot. For applications such as encapsulation or underfilling as described above, the pump and dispenser assembly is typically controlled to dispense lines of material as the pump and dispenser are moved in the x and y axes along the desired path of the lines.

The production rate of such dispensing systems, in some cases, may be limited by the rate at which a particular dispense pump assembly can accurately and controllably dispense dots or lines of material. In other cases, the production rate of such systems may be limited by the rate at which parts can be loaded into and out of the machine. In still other cases, the production rate of such systems may be limited by process requirements, such as the time required to heat a substrate to a particular temperature, or the time required for a dispensed material to flow, as in underfill applications. In all cases and applications, there is some limit to the throughput capability of a single dispense system.

During the manufacture of integrated circuits, production requirements often exceed the throughput capabilities of a single dispensing system. To overcome the throughput problem, multiple independent dispensing systems may be utilized to achieve the desired collective throughput. This solution is often expensive since multiple machines are used, and since additional manufacturing space is required. In typical operations, manufacturing floor space is both limited and expensive. It is therefore desirable to reduce the “footprint” of each manufacturing system on the manufacturing floor.

When a dispensing system is presented with a substrate or component to be dispensed upon, it is typical that an automatic vision system is used to locate and calibrate the actual position of the part and critical features within the part. This allows the system to compensate for variations in either the component itself or in the fixturing of the component relative to the coordinate system of the dispensing head positioning system.

When multiple dispensing heads are utilized in parallel to achieve a high collective throughput, it is typical that the multiple dispensing heads are programmed to perform substantially the same task on substantially identical components. However, because of slight variations in either the components themselves or in the fixturing of the components relative to the positioning systems, corrections must be applied independently to each of the multiple dispense heads. Since these corrections are unique to each of the multiple dispense heads, each of the dispensing heads are typically independently positionable relative to its substrate.

One prior art system achieves high throughput by utilizing multiple independent dispensing heads and is described in U.S. Pat. No. 6,007,631 entitled “Multiple Head Dispensing System and Method”, which is incorporated herein by reference, and is assigned to the assignee of the present application. This dispensing system utilizes multiple independent dispensing heads. Each of the multiple dispensing heads is mounted on a separate positioning system and operates over an independent work area. In addition, the system has two conveyor lanes to allow parts to be loaded into and out of the dispense work areas on one lane while the dispense heads continue to dispense on parts fixed in position in the other lane.

### SUMMARY OF THE INVENTION

It is desirable to achieve throughput advantages displayed in a multiple dispense head system and incorporate features of a dual-lane conveyor while further reducing the system cost and footprint of each printing machine. It is further desirable to provide continuous cycles in a batch machine that avoid downtime in a system, while maintaining the quality of resulting substrates.

Embodiments of the present invention achieve the throughput advantages of the prior art discussed above while further reducing footprint and cost by providing multiple independent dispense heads to dispense onto a plurality of substrates transported on pallets through the system. Using two lanes, each lane having a track, dispensing occurs on substrates transported on pallets on a first front track, while pallets on a second rear track are loaded with substrates in preparation for a next dispensing cycle. By working in a continuum, pallets on one of the first front track or the second rear track are substantially continuously positioned for dispensing, alleviating downtime or overhead associated with the dispensing process.

Further, in some embodiments of the present invention, smaller limited travel positioning systems are utilized to adjust the positions of the substrates relative to the dispensing heads. In other embodiments of the present invention, smaller limited travel positioning systems are mounted between each of the multiple dispensing heads and the common gantry positioning system.

In other embodiments of the present invention, one of the smaller limited travel positioning systems may be eliminated from one of the multiple heads without loss of generality. Since the position of each of the other heads may be adjusted relative to the position of the first head, unique corrections can still be applied to each of the multiple heads.

In other embodiments of the present invention, the travel range of the smaller limited travel motion systems may be made to be great enough to allow a dispensing pump to perform all necessary motion for a given component or part without requiring motion from the larger gantry positioning system. In such cases, the pattern dispensed by each of the multiple dispensing heads may be different than those of the other dispensing heads. An example of an application that would benefit from such a capability would be a dam & fill application in which one head is controlled to dispense a perimeter boundary of a dam material, while the other head is controlled to dispense a fill pattern of encapsulant within the dam.

In some embodiments of the present invention, aspects of the dual-lane conveyor are incorporated into multiple pallet loading fixtures. In such systems, the dispense heads continue to dispense on parts fixtured on one pallet while parts are loaded off of and then onto another pallet.

Embodiments of the present invention are not limited to dispensing systems and include other devices in which multiple work-heads perform substantially identical operations in parallel on multiple substantially identical work-pieces.

Implementations of the invention are directed to a system for performing operations on a plurality of workpieces. The system comprises an operations portion and a load/unload portion, a plurality of independently operable work heads located in the operations portion, the work heads each being operable to perform work on the plurality of workpieces, and a transfer system, the transfer system including a plurality of mounting devices, the transfer system being operable to deliver the mounting devices into and out of the operations portion of the system, wherein one of the plurality of mounting devices is positioned in the operations portion of the system and work is performed on the plurality of workpieces by at least one of the plurality of independently operable work heads while another one of the plurality of mounting devices is positioned in the load/unload portion of the system and workpiece-holding structures are unloaded from the mounting devices.

Embodiments of the invention can include one or more of the following features. The plurality of workpieces can be contained in workpiece-holding structures, the workpiece-holding structures being mountable on the plurality of mounting devices. The load/unload portion can be operable to load the workpiece-holding structures onto one of the plurality of mounting devices prior to delivery of the mounting devices into the operations portion by the transfer system to perform work on the plurality of workpieces by the independently operable work heads. The load/unload portion can be further operable to unload the workpiece-holding structures from one of the plurality of mounting devices.

Further embodiments of the invention can include one or more of the following features. The workpieces can be electronic substrates and the work heads can be dispensing heads. The workpiece-holding structures can be trays and the trays can hold electronic substrates. The trays can be AUER boats. The mounting devices can be pallets for holding the workpiece-holding structures. The work performed on the workpieces can be the dispensing of underfill onto the electronic substrates. A vision alignment apparatus can be included to align the independently operable work heads to the plurality of workpieces.

Implementations of the invention further include a method for performing operations on a plurality of workpieces using an apparatus having an operations portion and a load/unload portion; a plurality of independently operable work heads located in the operations portion, the work heads each being operable to perform work on the plurality of workpieces; and a transfer system, the transfer system including first and second mounting devices, the transfer system being operable to deliver the first and second mounting devices into and out of the operations portion of the system and out of and into the load/unload portion, respectively. The method comprises mounting workpiece-holding structures onto a first mounting device prior to delivery of the mounting devices into the operations portion to perform work on the plurality of workpieces by the independently operable work heads, moving the first mounting device into the operations portion using the transfer system to have work performed on the plurality of workpieces by at least one of the plurality of independently operable work heads, simultaneously moving the second mounting device using the transfer system to the unload portion, and when the first and the second mounting devices have been positioned, respectively, at the operations portion and the load/unload portion, performing work on the workpieces on the first mounting devices while unloading workpiece-holding structures from the second mounting device.

Embodiments of the invention can further include repeating prior steps such that workpiece-holding structures are unloaded from a mounting device after having had work performed on the plurality of workpieces contained in the workpiece-holding structures at approximately the same time period the workpieces which have not had work performed on them are delivered to the operations portion.

The invention will be more fully understood after a review of the following figures, detailed description and claims.

### BRIEF DESCRIPTION OF THE DRAWINGS

For a better understanding of the present invention, reference is made to the figures which are incorporated herein by reference and in which:

FIG. 1 is a perspective view of a dispensing system in accordance with one embodiment of the invention;

FIG. 2 is a side perspective view of the dispenser of FIG. 1 showing the substrate handling system in accordance with one embodiment of the invention;

FIG. 3 is a perspective view of the gantry system used in accordance with one embodiment of the invention;

FIG. 3B is a perspective view of an alternative gantry system used in accordance with one embodiments of the invention;

FIG. 4 is a perspective view of dispensing features in accordance with one embodiment of the invention;

FIG. 5 is a perspective view of the boat loading features in accordance with one embodiment of the present invention;

FIG. 6 is a perspective view of the boat loading features wherein the boat is being pulled in accordance with one embodiment of the invention;

FIG. 7 is a top view of the dispensing system of FIG. 1 in accordance with one embodiment of the invention; and

FIG. 8 is an alternative embodiment of the dispensing system of the present invention having multiple magazines.

### DETAILED DESCRIPTION OF PREFERRED EMBODIMENTS

Embodiments of the invention are directed to a multiple head dispensing system that performs a dispensing operation on a substrate such as a circuit board or other electronic component. As understood by those skilled in the art, embodiments of the invention are not limited to dispensing systems, but include other systems in which multiple work-heads perform substantially identical operations in parallel on multiple substantially identical substrates or workpieces. Embodiments of the invention can be directed to component placement systems, BGA placement systems, laser soldering systems, automatic optical inspection systems and machining systems. Embodiments of the invention are not limited to dispensing materials onto circuit boards or underfilling electronic components, nor are embodiments limited to use with multiple head dispensing systems, but may be used in single head applications. Other embodiments and processes are possible and envisioned.

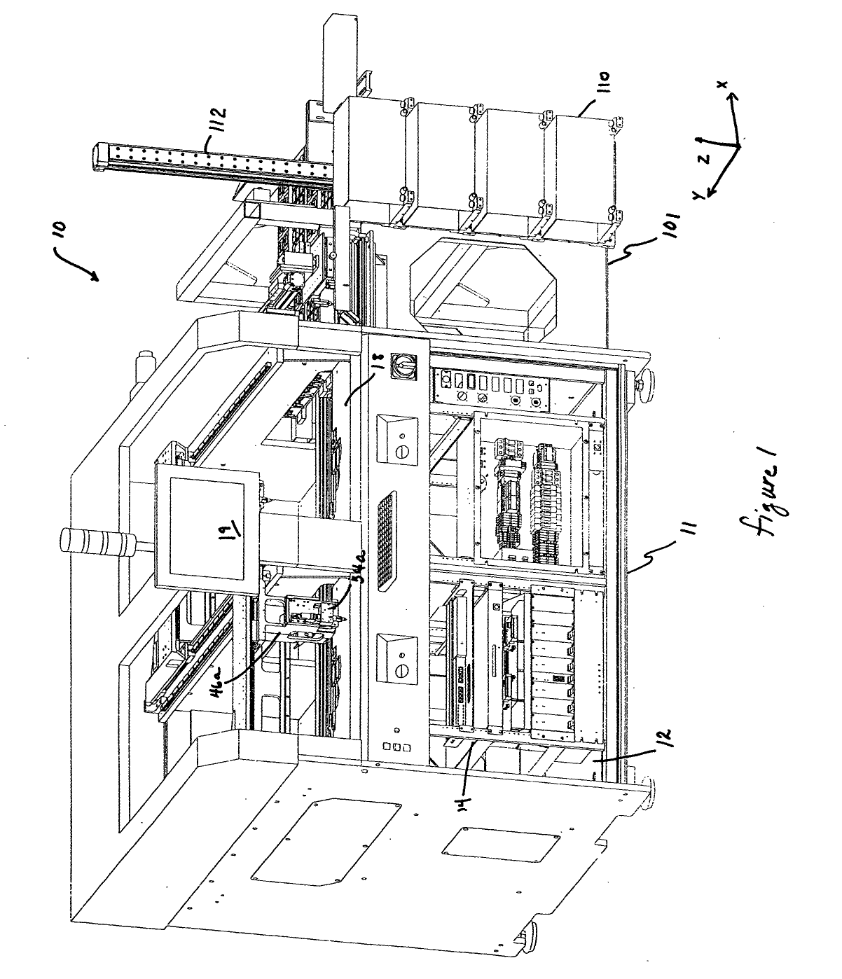

A multiple head dispensing unit in accordance with one embodiment of the invention is described with reference to FIGS. 1-3. FIG. 1 shows a perspective view of a multiple head dispensing system 10. The dispensing system 10 includes an operations system portion 11 and a substrate handling system portion 101, both portions working together to accomplish delivery of electronic components from the substrate handling system portion, dispensing onto electronic components in the operations system portion, and removal of electronic components to the substrate handling portion.

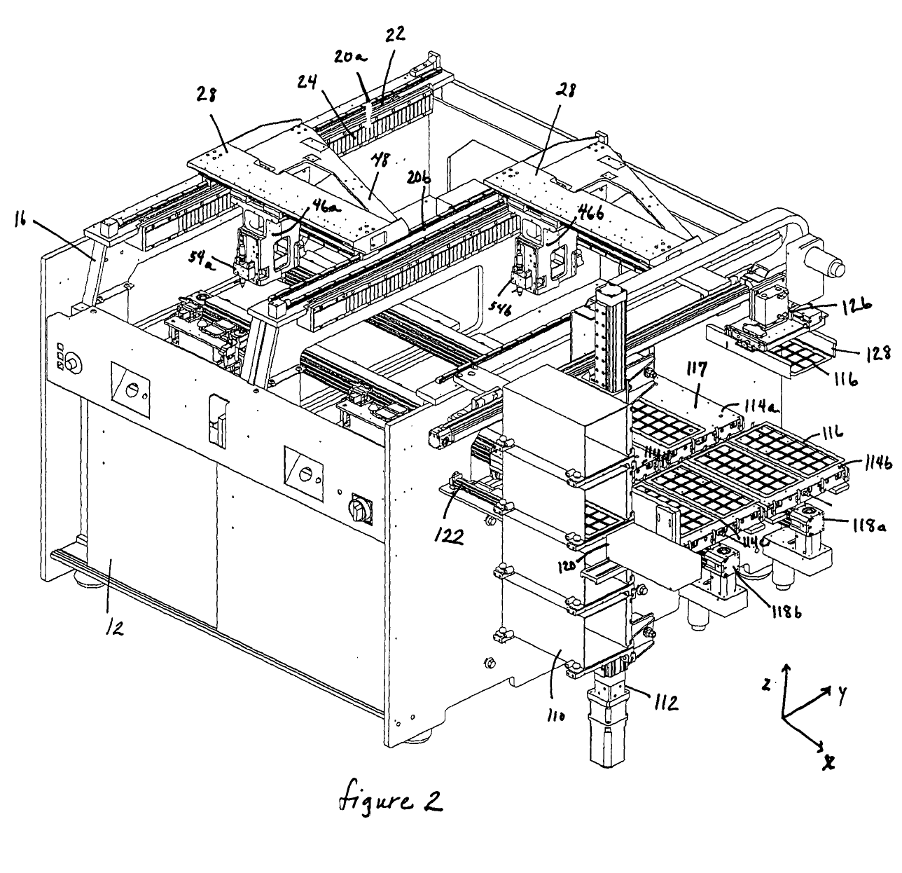

The operations system portion 11 is first described in detail. With further reference to FIG. 1 and referring to FIG. 2, the operations portion 11 includes a lower compartment 12, a primary system controller 14, a base frame 16, a mounting surface 18, a monitor or other graphical user interface 19, and a gantry positioning system 28 for each of dispense units 54a and 54b. The dispense units 54a and 54b include dispenser head housings 46a and 46b. The lower compartment 12 is used to house electrical and pneumatic controllers and the primary system controller 14. The base frame 16 provides a base for the gantry positioning systems 28 and the mounting surface 18.

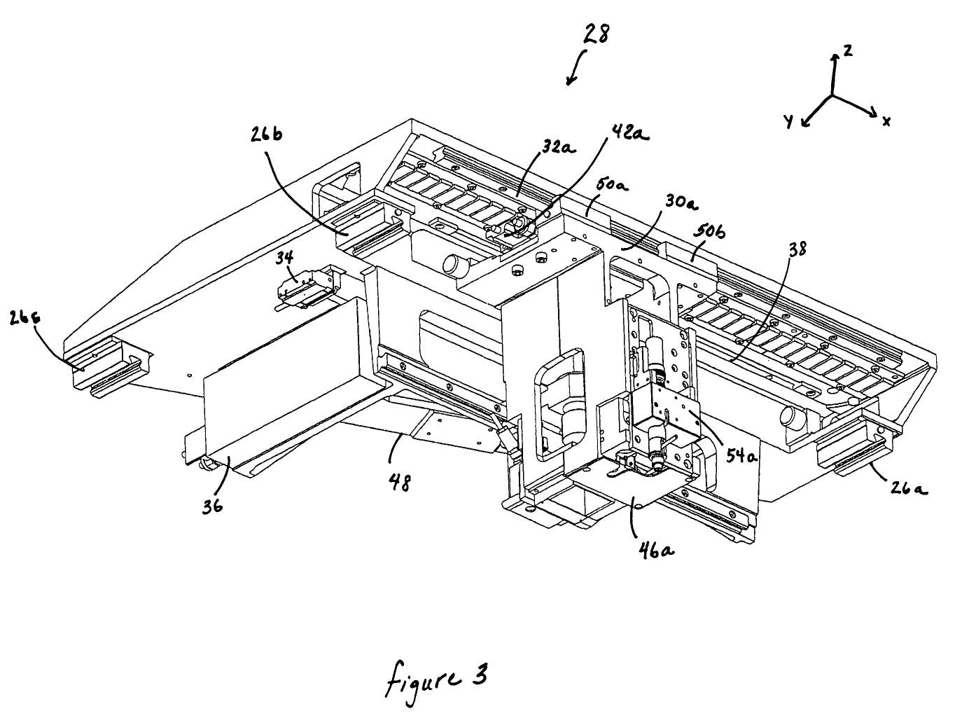

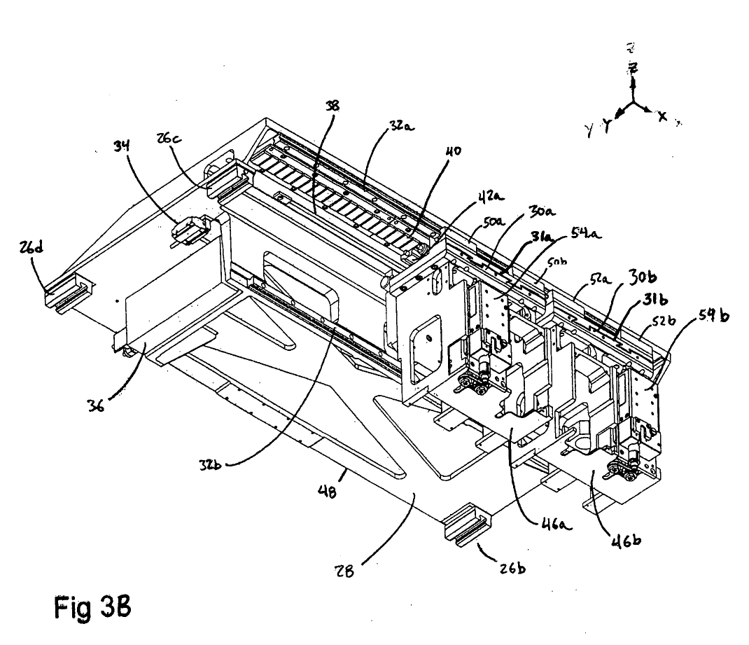

A gantry positioning system 28 (FIG. 2) is employed to move each of the dispenser units over the surface of a respective substrate. The gantry systems 28 of FIG. 2 are substantially identical, but independent, providing independent motion of each of the dispensers. It will be understood that while two such gantry systems are illustrated in FIG. 2, any number of such gantry systems may be utilized. Referring to FIG. 3, one of the gantry systems 28 of FIG. 2 is shown from a lower perspective and enlarged view. Each of the gantry positioning systems includes a Y axis positioning portion and an X axis positioning portion. The Y axis positioning portion is comprised of linear bearings 20a and 20b, a linear encoder tape scale 22, and a linear motor magnet track 24. The gantry positioning system 28 includes a gantry cross beam 48 which is slidably mounted in the Y axis to the base frame 16 using linear bearing sliders 26a, 26b, and 26c, as well as linear bearing rails 20a and 20b. Linear bearing slider 26a is slidably mounted to linear bearing rail 20b and linear bearing sliders 26b and 26c are slidably mounted to linear bearing rail 20a. Further included in the Y axis portion of the gantry positioning system 28 are encoder read head 34 and linear motor coil 36. The encoder read head 34 is mounted in close proximity to the linear encoder tape scale 22, from which it reads positional information. The encoder function performed with linear encoder tape scale 22 and encoder read head 34 may be implemented using a number of different encoder systems, including those manufactured by Renishaw PLC, of Gloustershire, UK.

The X axis portion of the gantry positioning system 28 includes a dispense head housing or carriage 30a, linear bearings 32a and 32b, and linear bearing sliders 50a, 50b, and 50c. The dispense head housing 30a is slidably mounted to the gantry cross beam 48 and linear bearing 32a using linear bearing sliders 50a and 50b, and to linear bearing 32b using linear bearing slider 50c (not visible). The dispense head housing 30a is driven by linear motor coil 42a. The position of the dispense head housing 30a is sensed by an encoder read head (not shown) that is similar in construction and mounting to the encoder read head 34 of the Y axis. The X axis encoder read head is mounted in proximity to and reads position information from encoder tape scale 38.

Mounted within the dispense head housings 30a and 30b are machine vision cameras (not shown), dispense heads 46a and 46b, and dispense units 54a and 54b, respectively. Dispense heads 46a and 46b are mounted in the dispense head housings 30a and 30b. The dispense heads 46a and 46b provide the Z axis of motion for dispense units/pumps 54a and 54b. For example, the dispense heads 46a and 46b can be implemented a number of ways. Likewise, dispense units 54a and 54b may be implemented using a number of different dispensing heads or pumps. Dispense units and dispensing heads or pumps can include those disclosed in U.S. Pat. No. 6,395,334 entitled “Multiple Head Dispensing System and Method”, which is assigned to the assignee of the present invention and is incorporated herein by reference.

In an alternative embodiment, multiple dispensing heads are mounted in a single gantry system, as shown in FIG. 3B. In FIG. 3B, rather than independent dispense heads, two partially dependent heads are mounted on a single gantry. The gantry cross beam assembly 28 is comprised of gantry cross beam 48, X carriages 30a and 30b, dispense units 54a and 54b, and dispenser head housings 46a and 46b. X carriage 30a is slidably mounted to gantry cross beam 48 and linear bearing 32a using linear bearing sliders 50a and 50b. X carriage 30b is slidably mounted to gantry cross beam 48 and linear bearing 32a using linear bearing sliders 52a and 52b. X carriage 30a is slidably mounted to gantry 30 cross beam 48 and linear bearing 32b using a linear bearing slider. X carriage 30b is slidably mounted to gantry cross beam 48 and linear bearing 32b using a linear bearing slider. Both carriages 30a and 30b share a common set of bearing rails 32a and 32b, a common encoder tape scale 38 and a common linear motor magnet track 40. X carriage 30a is driven by linear motor coil 42a. X carriage 30b is also driven by a linear motor coil (not shown). The position of X carriage 30a is sensed by an encoder read head (not shown) that is similar in construction and mounting to the encoder read head 34 of the Y axis. The position of X carriage 30b is sensed by an encoder read head (not shown) that is similar in construction and mounting to the encoder read head 34 of the Y axis. These X axis encoder read heads are mounted in proximity to and read position information from encoder tape scale 38. Linear bearings 31a and 31b positioned between the dispenser housings 46a and 46b and the common gantry system 28 provide a limited travel positioning system between each of the dispensing heads 54a and 54b and the common gantry system 28. Thus, in a system comprised of a single gantry system, the dispensing heads 54a and 54b can adjust their respective positions in the Y axis direction to correspond to a position of the substrates.

In still another alternative embodiment, the addition of a second dispense unit within a dispensing head housing is possible and provides the capability to dispense two different materials from a given dispensing head or to dispense the same material from differently configured dispense units, such as from two different needle sizes, a feature shown in FIG. 3B. Two dispense heads can be mounted side by side in a single, wider dispense head housing on each gantry. The dispense heads on each gantry can be fixed to each other in the X and Y axes. If use of a second dispense unit is not anticipated or desired, dispense head housing 46a and/or 46b may be constructed to eliminate the structure and features required to accommodate the presence of a second optional dispense unit.

In order to achieve accurate dispensing on chips, it is useful for the dispense units to learn the location and height of the substrates onto which dispensing is to occur before beginning a respective dispensing process. For example, a vision alignment system can be used during the dispensing process so that precise locations and heights are determined. Accurate dispensing can require multiple passes of epoxy or other materials that flow in capillary fashion under a chip and around each interconnection on the chip.

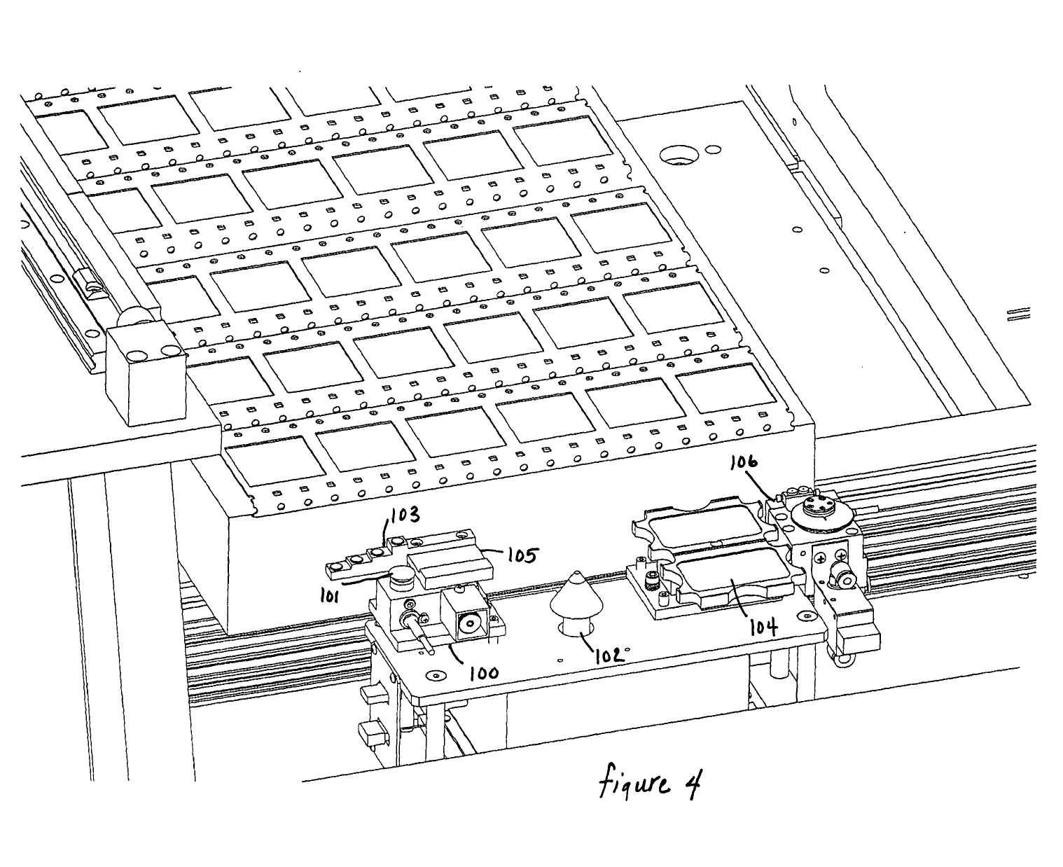

Each of the dispense units 54a and 54b has associated with it features used in the dispensing unit for accuracy and efficiency in the dispensing process. Referring to FIG. 4, each head of the dispensing system 10 includes a respective station having a needle calibrator 100, weight scales 102, pre-dispense plates 104, and needle cleaners 106. Each station can further include a bent needle detector (not shown). The needle calibrator 100 includes a plunger, or switch, 101, a step block 103, and a gauged step plate 105. The height of the needle is determined by activation of the plunger 101 by contact from the needle. The step block 103 is used to calibrate a non-contact laser Z-height sensor, which, if present, is mounted within dispense head housing 30a. This laser Z height sensor can include those manufactured by Micro-Epsilon of Ortenburg, Germany. The gauged step plate 105 is used to calibrate a contact Z sensor which, if present, is mounted within dispense head housing 30a. This contact Z sensor can include those described in commonly owned U.S. Pat. No. 6,093,251, the disclosure of which is herein incorporated by reference.

The frusta conical base of the weight scales 102 is shown, while the dish associated with the weight scales is removed in FIG. 4. The weight scales generally includes a dish, or cylindrical chamber, as well as a removable lid, which allows for dispensing into the chamber, but further acts as a draft shield and an electrostatic shield. The weight scale system and methods to utilize same can include those described in commonly owned U.S. patent application Ser. No. 09/705,080, now U.S. Pat. No. 6,541,063, and U.S. patent application Ser. No. 09/928,112, the disclosures of which are incorporated herein by reference.

The pre-dispense plates 104 act as surrogate substrates upon which preliminary dispensing can be performed prior to dispensing on actual substrates being processed. The preliminary dispense step allows the condition of the needle and the particular formation of material at the end of the dispensing needle to more closely emulate the condition of the needle that exists after dispensing on actual workpieces. Thus, the preliminary dispense step serves to minimize variations between the first and subsequent products produced. The preliminary dispense step is typically programmed to occur subsequent to actions that could change the condition of the needle, such as dispensing into the weight scale dish or cleaning the needle. The pre-dispense plates 104 can include a ceramic insert which can be removed for cleaning and replaced for additional use. The use of more than one pre-dispense plate 104 allows for an increase in the number of preliminary dispense events possible before operator intervention is required.

The needle cleaners 106 can include the needle cleaner described in commonly owned U.S. patent application Ser. No. 09/974,022, the disclosure of which is herein incorporated by reference.

A bent needle detector can be included as part of the needle calibration station. The bent needle detector may have a switch similar to switch 101 associated with it. The switch can have an aperture on its top surface wherein the needle, when straight, enters. If the needle is not straight, it will activate the switch. Activation of the switch can lead to corrective measures in properly aligning the needle.

Further features included in and associated with each of the multiple dispensers included in the system 10 are machine vision alignment and machine vision inspection. A vision processor can control and process signals received from cameras mounted on the gantry systems, and can provide processed vision signals to a system controller. The cameras may be used: to locate fiducial marks on workpieces loaded into the dispensing system for alignment purposes; to inspect workpieces after material has been dispensed, or some other operation has been performed; and to identify a type of workpiece loaded into the dispensing system.

As mentioned, to properly transport substrates to a position in preparation for dispensing, the multiple head dispensing unit 10 includes a substrate handling system portion 101, as shown in FIGS. 1 and 2. The substrate handling system portion 101 prepares and transports the substrates prior to and subsequent to an operation being performed on the substrates in the operations portion of the dispensing unit 10. Referring to FIGS. 1 and 2, the substrate handling system portion includes magazines 110, an elevator 112, pallets 114a, 114b, 114c, and 114d, boats 116, tracks 118a and 118b, a pusher 120, a boat shuttle 122 and an overhead gripper 126. The boat shuttle includes a grabber 124. The magazines 110 are loaded with a plurality of boats 116, each boat holding one or a plurality of substrates, or one or a plurality of rows of substrates. These boats 116 may be of a known type, such as an AUER boat, or any other suitable carrier for chips or other substrates to be dispensed upon. The magazines 110 are positioned in a stack near a front portion of the substrate handling system portion 101. A stack of magazines can be comprised of four magazines 110, although more than four magazines 110 in a stack is acceptable. Alternatively, less than four magazines can be included in each stack. A plurality of boats 116 are stacked in each of the magazines. Each magazine can hold 5, 10, 12, or more boats, for example. The magazines 110 are moveable in a Z axis direction along the height of the elevator 112. Motion of the magazines 110 in the z axis direction allows the magazines to shift to a position such that a boat 116 is horizontally aligned for removal from a slot in the magazine 110 or for return to a slot in the magazine 110 as necessary. The elevator 112 indexes to the slot height of the boat 116 that is to be removed from the magazine 110, and subsequent boats thereafter. The elevator 112 further performs scanning of the magazines to perform presence/absence checking of the boats. The elevator 112 can be continuously moved from an upper position to a lower position such that each boat 116 is moved past a sensor, thereby efficiently indicating which boats are present.

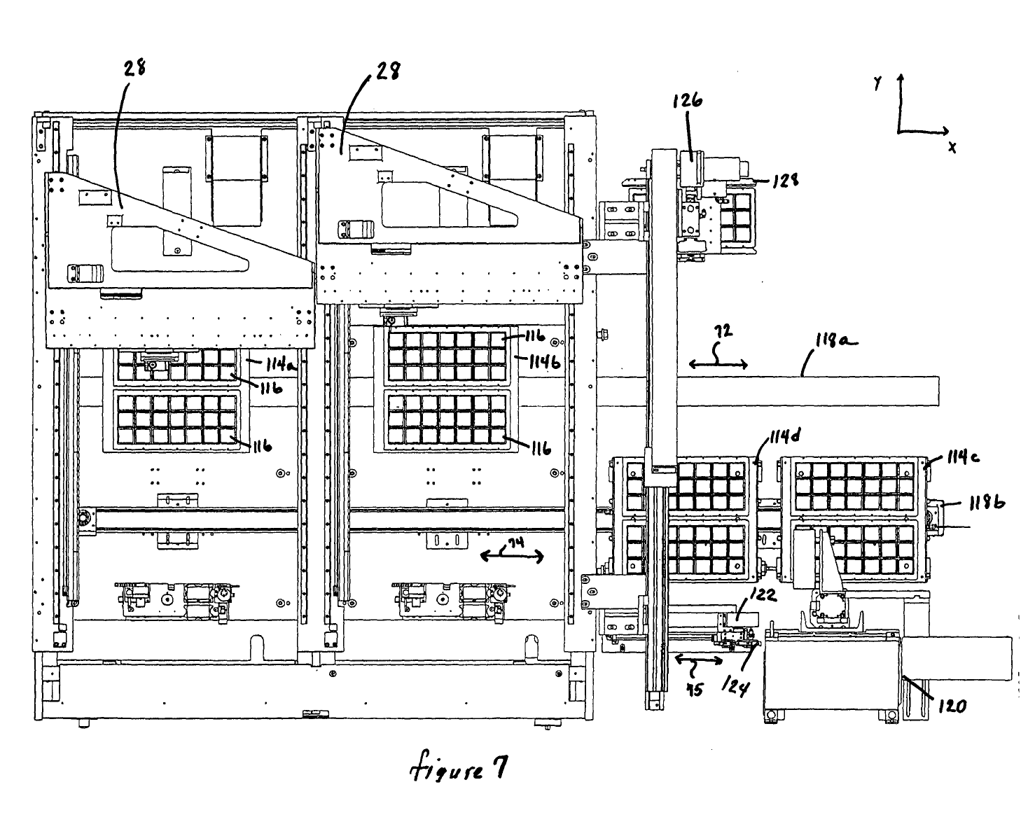

Referring to FIG. 7, pallets 114a, 114b, 114c, and 114d lie in a horizontal plane on tracks 118. Pallets 114a and 114b lie on a common rear track 118a, while pallets 114c and 114d lie on a common front track 118b. The tracks 118 extend from the substrate handling section 101 and through the operations portion 11. Pallets 114a and 114b are positioned adjacent to one another on the rear track 118a. Pallets 114c and 114d are positioned adjacent to one another on the front track 118b. The pallets 114 include top plates 117 that can be custom manufactured to accept any of a number of configurations of substrates that are being manufactured. The top plates 117 can be removed from the body of the pallet, such that a replacement top plate or a top plate 117 having a different configuration to receive different substrates can be used. Further, the top plates can be heated in some applications. The pallets 114 are further designed to accept one or a number of boats 116 received from the magazines 110. In a preferred embodiment, each of pallets 114a, 114b, 114c, and 114d accepts two boats 116 of substrates. In the example shown, each boat 116 includes three columns of electronic components. Thus, in this example, six columns of electronic components can rest on each pallet simultaneously.

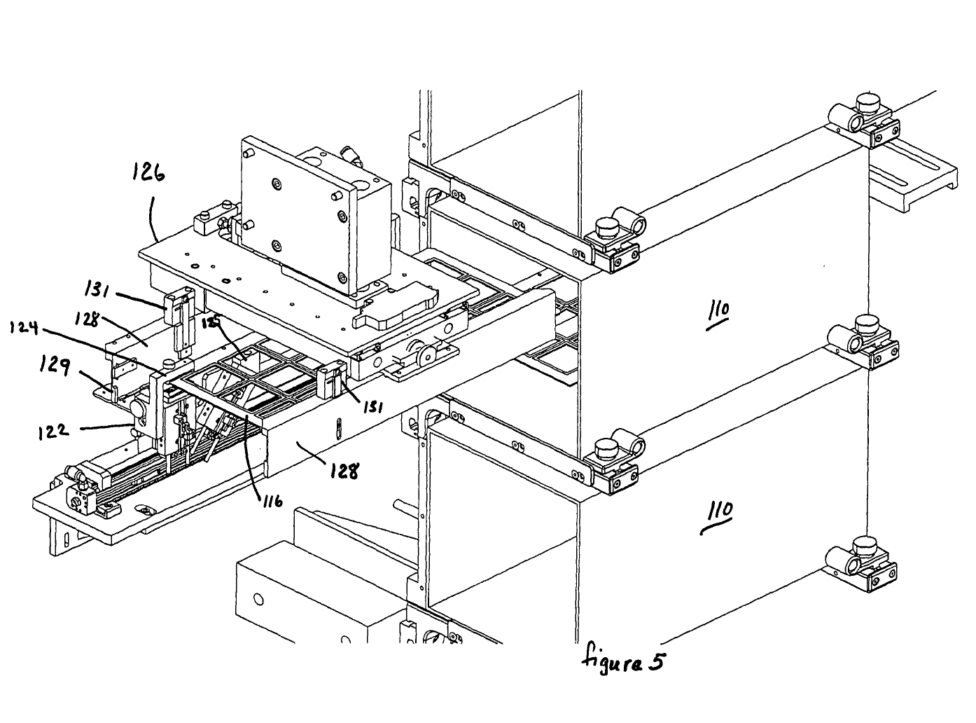

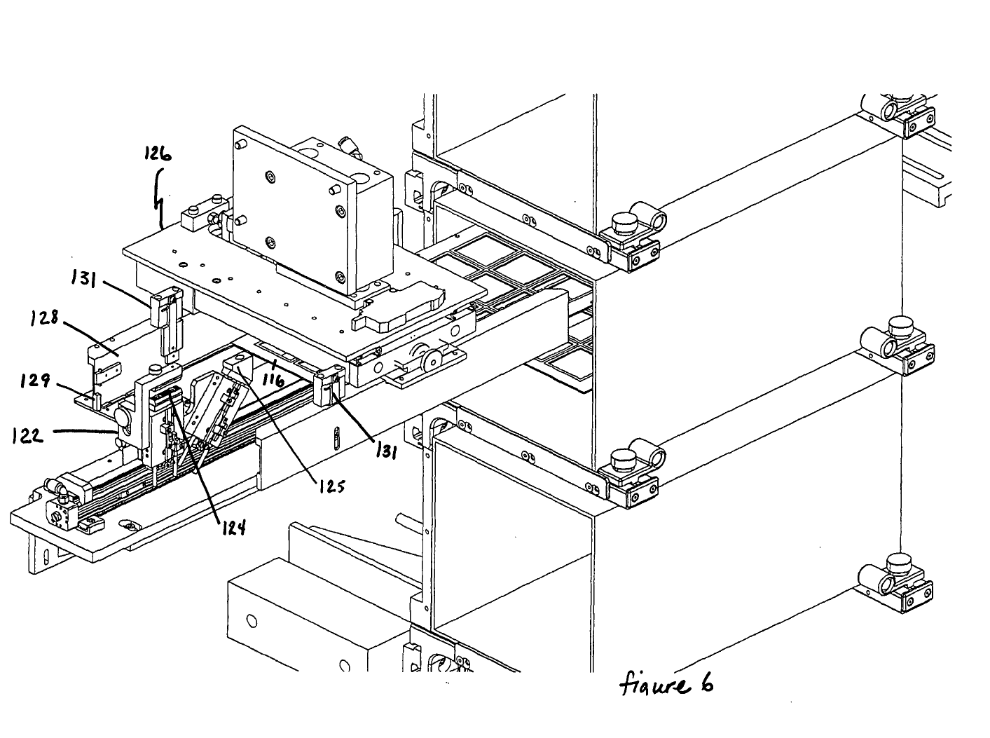

The pusher 120 is positioned at an outboard end of the magazine 110. The pusher can be pneumatically actuated, or, in the alternative, the pusher can be actuated using a servomotor or other actuating device. The boat shuttle 122 is preferably positioned with a servo motor, but could in the alternative be actuated pneumatically. Referring to FIGS. 5 and 6, the boat shuttle 122 is positioned at an inboard end of the magazine 110 and includes a grabber 124 positioned at a height substantially equivalent in height with a boat in the magazine such that the grabber 124 moves in an X axis of motion, indicated by arrow 75, toward the magazine to grab a boat from the magazine 110. Alternatively, the grabber 124 can be constructed to move in both the X axis and the Z axis, such that the grabber removes boats 116 from the magazines 110 at differing heights and positions.

Referring to FIGS. 2, 5 and 6, the overhead gripper 126 handles and transports boats 116 between the magazine 110 and the pallets 114. The overhead gripper 126 includes parallel side plates 128, each having a ledge running along the inside edge of the respective side plate 128. The ledges provide a narrow shelf to support the longitudinal edges of the boats 116 when the boats are removed from the magazine 110. The overhead gripper 126 is pneumatically actuated and can move from a position over the pallets 114 to a position to receive the boats 116. The overhead gripper 126 need not be pneumatically actuated, but may be actuated by a servomotor or other source. In addition, the parallel side plates 128 of the overhead gripper, as shown in FIG. 2, are actuatable to an open or closed position, moving further away from or closer to each other about a centerline such that the space between the parallel side plates increases or decreases. When the overhead gripper 126 is closed, the boat can be pushed into the space between the parallel side plates and be supported on the ledges that run along the bottom edge of the parallel side plates for transport.

It is desirable to move boats 116 having substrates from a position in the magazines 110 to a fixed position on a pallet 114, such that the pallets can move through the dispensing system for performance of a dispensing operation on the substrates. Boats 116 positioned in the magazines 110 hold electronic components ready to be dispensed upon. The pusher 120 is actuated to push a boat 116 from the outboard side of the magazine 110 so that the boat is partially extended from the magazine 110. The overhead gripper 126 is positioned at the inboard side of the magazine 110 in an open position. The boat shuttle 122, also positioned on the inboard side of the magazine 116, reaches through the overhead gripper 126 with the grabber 124, which is mounted on the boat shuttle. As shown in FIG. 5, the grabber 124 grasps the boat 116 and retracts, withdrawing the boat from the magazine 110 and pulling the boat 116 into position in the overhead gripper 126. Parallel side plates 128 each incorporate a stop feature 129 at the inboard end. When the grabber 124 has completed the X axis stroke of removing the boat 116, the grabber keeps the boat positioned against the stop features 129 on the overhead gripper 126 such that the boat 116 is substantially snugly held in position. Clamp cylinders 131 mounted on the inside faces of the long parallel side plates 128 of the overhead gripper 126 secure the boat 116 within the overhead gripper 126. Once the boat 116 is secured, the grabber 124 unclamps and the boat shuttle 122 retracts to a rest position. Thus, the original position of the boat 116 within the magazine 110 is not a factor, since the boats 116 are repeatably and reliably located within the overhead gripper.

With the boat securely positioned in the overhead gripper, the overhead gripper 126 moves from a position adjacent to the magazine 110 to a placement position over one of the pallets 114a, 114b, 114c, and 114d. The overhead gripper can first transport an individual boat 116 for placement on pallet 114a, for example. The boat 116 is positioned on the pallet 114a and secured into position by a vacuum system which fixedly holds the boats in position. The vacuum system can be selectively disabled and enabled to fix an entire pallet. Alternatively, the vacuum can be applied to specific boat locations within a pallet individually. A vacuum sensor which may be located on one or more of the pallets 114a, 114b, 114c, and 114d provides feedback if one or more of the parts within the boats 116 is either not present or improperly seated. For example, if one or more parts is/are not properly seated on the vacuum apertures on the top plate, there will be air leakage into the vacuum holes. Because of the air flow, there is some loss of vacuum which the sensor detects as a low vacuum level. The pallet 114a remains in position while the overhead gripper 126 returns to a position at the inboard side of the magazine 110 to load a next boat 116. Using the same method as that described above, a second boat 116 is removed from the magazine 110 and transported by the overhead gripper 126 to a second position on pallet 114a. Upon securely fastening the boat to pallet 114a, pallet 114a is fully loaded. In alternative configurations, for example if boats 116 each contain only one row of substrates, pallets 114 may have room for more than two boats 116. The gripper 126 is accordingly used to load as many boats 116 onto the pallet 114 as can be accommodated by a particular configuration.

Pallet 114b shares a track 118 with pallet 114a, as seen in FIG. 2 and FIG. 7. For example, pallets 114a and 114b are positioned adjacent one another on a rear track 118a of the dispensing system 10. The overhead gripper 126, repeating the placement process, works to load a first and a second boat 116 onto pallet 114b following the same process by which boats are loaded onto pallet 114a. Fully loaded pallets 114a and 114b traverse along the rear track 118a into the operations portion of the dispensing system 10 for a dispensing process. The pallets 114a and 114b are separated by an adjustable distance, as shown in FIG. 7, by a pneumatic actuator within the operations portion. While at the load station, there is substantially no dead space between the pallets 114a and 114b, providing a more compact system. The pallets, however, may separate a required distance when the pallets are positioned in the dispenser in the operating portion. Thus, the dispenser heads can be appropriately positioned a distance from one another and the pallets 114a and 114b can separate to coordinate with the ability of the dispensers to dispense on respective pallets. The adjustable distance allows the loading area for the dispensing system 10 to be compact.

Upon entry of the pallets 114a and 114b into the operations portion in the direction indicated by arrow 72, the dispensing process begins. The two dispenser heads shown in FIGS. 2 and 7 move independently of one another. Thus, when pallets 114a and 114b move into a position for dispensing, the dispensers move to the side of the operations portion at which the pallets are located. For example, the dispensers move to the rear portion of the system when dispensing on pallets 114a and 114b, so that dispensing can occur on pallets 114a and 114b substantially simultaneously, while pallets 114c and 114d are being removed after having been dispensed upon by the dispensing heads 28. This allows for full throughput and maximum use of the dispensers so that at approximately the time at which dispensing is completed on one set of pallets, the other loaded pallets are moved into the dispenser. The process of dispensing, thus, continues cyclically.

Typically, the process of dispensing is comprised of the steps of measuring the height of the top surface of the substrates in the Z direction using either a contact or non-contact height sensor, determining the precise position of the substrate in X and Y by means of a machine vision system, calculating any required X/Y offset corrections based on the precise position, and performing the required dispensing steps prescribed in a pattern recipe. The pattern recipe provides a programmatic means by which the dispensing system is instructed what and how to dispense on the substrates.

In addition, prior to dispensing, a vision system has the ability to do a mass alignment by doing an alignment check on substrates in a pallet, allowing alignment to be checked for multiple substrates at once. A camera and other hardware can be incorporated into the materials handling system portion of the dispensing system. While a dispensing process is in progress, substrates on pallets prepared for a next dispense cycle can be aligned using the vision system in the materials handling portion. The alignment of each substrate can thus be learned relative to fiducials on the pallets themselves. This is advantageous in that it further improves throughput efficiency by checking alignment before pallets are inserted for dispensing, such that the vision system in the dispenser, having access to the pre-alignment information obtained by the material handling portion, need only check fiducials on the pallets themselves, rather than check alignment fiducials on each of the substrates on the pallet, which may be numerous. In addition, the off-line camera in the materials handling portion can perform post-dispense inspections.

While the electronic substrates on pallets 114a and 114b receive material during dispensing, pallets 114c and 114d are loaded with additional boats holding substrates. Thus, a process is performed on the substrates transported along the rear track 118a substantially simultaneously with a loading process being conducted on the front track 118b, as shown in FIG. 7. The loading process on pallets 114c and 114d is a repeat of the loading process on pallets 114a and 114b. When loading is completed, pallets 114c and 114d traverse along the front track 118b into the operations portion 11 in a direction indicated by arrow 74 to a position for dispensing. Upon completion of the dispensing process, the dispensing heads move along respective gantry systems 28 to re-position over the front rail for the next dispensing process. Pallets 114a and 114b traverse the rear track along the X axis to return to a rest position in the loading/unloading area of the substrate handling system.

Pallets 114a and 114b are prepared for unloading. The boats 116 on pallets 114a and 114b are returned to the magazine 110 from which they were removed. The overhead gripper 126 removes a boat 116 from pallet 114a and transports it to a position at the inboard end of the magazine 110. The boat shuttle 122 is positioned to push the boat back into the magazine 110. As shown in FIG. 6, the grabber 124 remains in a closed position to push the boat partially into the magazine. The boat shuttle 122 retracts. A second pusher 125, mounted to the boat shuttle, extends to a position behind the boat 116. The boat shuttle 122 advances a second time to complete pushing the boat 116 into the magazine 110. The second pusher 125 allows use of a boat shuttle 122 with a substantially short stroke compared to that required if the grabber 124 is used to push the boat completely into the magazine 110. Alternatively, however, the grabber 124 can be used to push the boat into the magazine 110 without use of a second pusher 125 mounted to the boat shuttle. Boats 116 are replaced in the same magazine slot from which they were taken prior to processing. The electronic components in each boat can be tracked by placing the electronic components in the same boat position, in the same slot position of the same magazine from which they are removed.

In embodiments of the invention, magazines hold a plurality of boats that are prepared for dispensing, and an elevator positions the magazines at varying heights whereby boats can be received. In an alternative embodiment, continuous flow loaders and unloaders are used to insert boats into the dispensing system and remove boats from the dispensing system after dispensing has been completed. Magazines are presented at one location and retrieved from a separate location after processing. A queue of unprocessed magazines and an additional queue for processed magazines allows for time intervals between servicing.

In embodiments of the invention, the overhead gripper is used to transport boats from the magazines to the pallets, and from the pallets to the magazines. In other embodiments of the invention, the overhead gripper can be fitted to automatically change the top plates of the pallets as required, thus improving change over operations in the system. Further, the top plates are heated, and if the top plates remain hot, the top plates would have to be allowed to cool before manual handling. Automatically changing the top plates with the overhead gripper saves considerable cooling time.

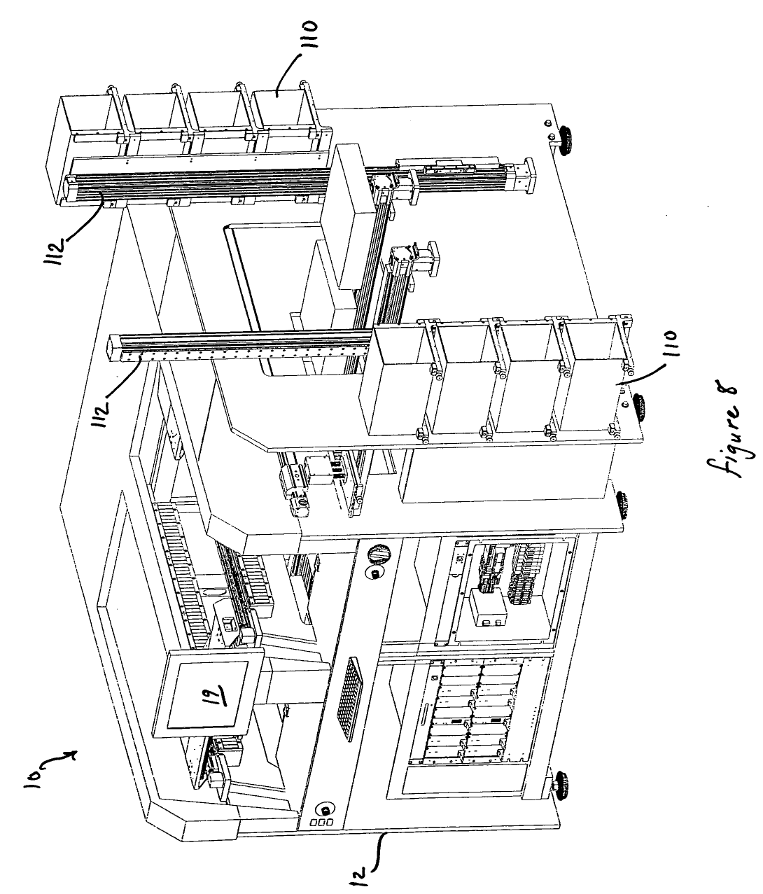

In embodiments of the invention, a single elevator is used to move magazines to varying heights and to provide substrates for both dispensing heads. Alternative embodiments of the invention can include a second elevator positioned on an opposite side of the substrate handling system to further provide magazines to the system. The use of two elevators doubles the number of magazines available to the system, thereby substantially increasing the time interval between operator interventions, which are a time cost to production. Additionally, a plurality of stacks of magazines can be introduced into the system, such that one, two, three, four, or more stacks of magazines are positioned at respective areas around the substrate handling system. An embodiment of the present invention having two magazine stacks is depicted in FIG. 8. An increase in the number of magazines also reduces the need for operator intervention.

In embodiments of the invention, the elevator can be used to preheat and/or post-heat parts outside of the machine process to increase throughput by reducing gating process time. Likewise, heating a continuous flow loader/unloader can reduce cycle time and increase throughput, while also minimizing process variations by causing all parts to experience the same thermal profile. Further, heating the elevator or continuous flow loader allows the system to monitor pre-heat and post-heat times.

In figures depicting the dispensing system of the current invention, a right-handed system is shown. A modular design of the system allows the system to be built in a right-handed or a left-handed orientation. The ability to assemble systems in either of these two orientations allows users of the system to best optimize the productivity and workflow in a given facility by locating the material handler portion where loading and unloading operations can be performed most efficiently.

In embodiments of the invention, some of the actuators in the substrate handling portion of the dispensing system are pneumatic. As is apparent to one skilled in the art, servo driven or stepper driven motors can be used to actuate devices in the dispensing system, such as the overhead gripper, the boat shuttle, the magazines, and the pallets.

Having thus described at least one illustrative embodiment of the invention, various alterations, modifications and improvements will readily occur to those skilled in the art. Such alterations, modifications and improvements are intended to be within the scope and spirit of the invention. Accordingly, the foregoing description is by way of example only and is not intended as limiting. The invention's limit is defined only in the following claims and the equivalents thereto.

What is claimed is:

1. A system for performing operations on a plurality of workpieces, the system comprising:
an operations portion and a load/unload portion;
a plurality of independently operable work heads located in the operations portion, the work heads each being operable to perform work on the plurality of workpieces;
a transfer system, the transfer system including a plurality of mounting devices, the transfer system being operable to deliver the mounting devices into and out of the operations portion of the system,
the plurality of workpieces being contained in workpiece-holding structures, the workpiece-holding structures being mountable on the plurality of mounting devices;
the load/unload portion being operable to load the workpiece-holding structures onto one of the plurality of mounting devices prior to delivery of the mounting devices into the operations portion by the transfer system to perform work on the plurality of workpieces by the independently operable work heads;
the load/unload portion being further operable to unload the workpiece-holding structures from one of the plurality of mounting devices,
wherein one of the plurality of mounting devices is positioned in the operations portion of the system and work is performed on the plurality of workpieces by at least one of the plurality of independently operable work heads while another one of the plurality of mounting devices is positioned in the load/unload portion of the system and workpiece-holding structures are unloaded from the mounting devices.

2. The system of claim 1, wherein the workpieces are electronic substrates and the work heads are dispensing heads.

3. The system of claim 1, wherein the workpiece-holding structures are trays and the trays hold electronic substrates.

4. The system of claim 3, wherein the trays are AUER boats.

5. The system of claim 1, wherein the mounting devices are pallets for holding the workpiece-holding structures.

6. The system of claim 2, wherein the work performed on the workpieces is the dispensing of underfill onto the electronic substrates.

7. The system of claim 1, wherein each of the independently operable work heads further comprises a vision alignment apparatus to align the independently operable work heads to the plurality of workpieces.

8. A method for performing operations on a plurality of workpieces using an apparatus having an operations portion and a load/unload portion; a plurality of independently operable work heads located in the operations portion, the work heads each being operable to perform work on the plurality of workpieces; a transfer system, the transfer system including first and second mounting devices, the transfer system being operable to deliver the first and second mounting devices into and out of the operations portion of the system and out of and into the load/unload portion, respectively; the plurality of workpieces being contained in workpiece-holding structures, the workpiece-holding structures being mountable on the first and second mounting devices; the load/unload portion being operable to load the workpiece-holding structures onto one of the mounting devices and to unload the workpiece-holding structures from one of the mounting devices, the method comprising:
(a) mounting the workpiece-holding structures onto a first mounting device prior to delivery of the mounting devices into the operations portion to perform work on the plurality of workpieces by the independently operable work heads;
(b) moving the first mounting device into the operations portion using the transfer system to have work performed on the plurality of workpieces by at least one of the plurality of independently operable work heads;
(c) moving the second mounting device using the transfer system to the unload portion;
(d) when the first and the second mounting devices have been positioned, respectively, at the operations portion and the load/unload portion, performing work on the workpieces on the first mounting devices while unloading workpiece-holding structures from the second mounting device.

9. The method of claim 8, further comprising repeating steps (a), (b) and (c) such that workpiece-holding structures are unloaded from a mounting device after having had work performed on the plurality of workpieces contained in the workpiece-holding structures at approximately the same time period the workpieces which have not had work performed on them are delivered to the operations portion.

10. An apparatus for performing operations on a plurality of workpieces comprising:
an operations portion and a load/unload portion;
a plurality of independently operable work heads located in the operations portion, the work heads each being operable to perform work on the plurality of workpieces; and
a transfer system, the transfer system including a plurality of mounting devices, the transfer system being operable to deliver the mounting devices into and out of the operations portion of the system,
wherein the plurality of workpieces being contained in workpiece-holding structures, the workpiece-holding structures being mountable on the plurality of mounting devices, and
wherein one of the plurality of mounting devices is positioned in the operations portion of the system and work is performed on the plurality of workpieces by at least one of the plurality of independently operable work heads while another one of the plurality of mounting devices is positioned in the load/unload portion of the system and workpiece-holding structures are unloaded from the mounting devices.
